(19) United States
(12) Patent Application Publication
(10) Pub. No.: US 2020/0217016 A1
(43) Pub. Date: Jul. 9, 2020

(54) OPAQUE PAPER WITHSTANDING IMMERSION

(71) Applicant: PAPETERIE ZUBER RIEDER, Boussieres (FR)

(72) Inventors: Alice REJSEK, Montboillon (FR); Michel GERMAIN, Domène (FR)

(73) Assignee: PAPETERIE ZUBER RIEDER, Boussieres (FR)

(21) Appl. No.: 16/648,818

(22) PCT Filed: Sep. 20, 2018
(86) PCT No.: PCT/FR2018/000219

§ 371 Date: Mar. 19, 2020

(30) Foreign Application Priority Data
Sep. 22, 2017 (FR) FR1758808

(51) Int. Cl. D21H 21/28; D21H 17/67; D21H 17/68; D21H 19/38; D21H 19/40; G09F 3/02

(52) U.S. Cl. CPC D21H 21/28; D21H 17/675; D21H 17/68; G09F 2003/0273; D21H 19/40; G09F 3/02; D21H 19/385

(57) ABSTRACT

An opaque paper which can withstand immersion for producing a label which is intended mainly for bottles of wines or spirits, and which is remarkable in that it is constituted by a basic paper substrate which is constituted by fibres and opacifying mineral fillers, the basic paper substrate being subjected on the front and rear faces to a surface treatment which is constituted by mineral pigments or other pigments which are associated with hydrosoluble and synthetic binders. The disclosure also relates to a label and the method for producing it from the paper.

### TECHNICAL FIELD

The present invention relates to the field of producing paper, and more precisely that of uncoated paper, for the purpose of producing labels that have information on their rear face and intended to be affixed on a substrate, mainly of the bottle type of wines or spirits, likely by its nature to be stored in a humid environment such as, for example, a refrigerator, an ice bucket or any other method of storage, preservation or presentation intended for example to cool them and maintain them at an adequate temperature.

### PRIOR ART

In this particular field, it is known that the maintaining of the rear face of the label on the bottle, through a glue, was not sufficient for the label to retain its original aspect, when it was subjected to humidity, in particular when immersed in water.

This problem is all the more so detrimental for papers with strong whiteness and opacity which today are experiencing steady growth.

Indeed, in order to obtain a label of good quality with this type of paper in particular, it is necessary to satisfy the following quality criteria:
the white paper must always retain an intense whiteness for aesthetic reasons,
it must have a reinforced opacity, regardless of the environment (dry or humid) wherein it is located,
the paper must withstand water, an ice bucket in particular, because in contact with water, infiltrations occur under the paper which cause the appearance of air bubbles and create an unsightly aspect,
after passing through a humid environment the label must retain its original aspect.

The uncoated labels on the market only very rarely satisfactorily meet the four criteria mentioned hereinabove. Dry whiteness and opacity are relatively frequently obtained, but the resistance to water and the humid opacity are not sufficient when the immersion is long, for example at least one hour for so-called “ice bucket” passages.

In order to overcome these disadvantages, a paper for labels that is opaque in a dry and humid environment is already known such as the one described in European patent application EP 2 122 052 granted in the name of the Applicant. Said paper for labels is formed from a basic paper substrate uncoated on the rear side on which is applied, by any means, at least one layer of a liquid polymer, in which is incorporated an opacifying agent or filler, intended to provide said product a dry and humid opacity, added to that of the uncoated basic paper substrate, in such a way as to produce an opaque layer and which limits the passage of water, between the product to be labelled and the uncoated basic paper substrate, for a use of the product in the humid environment or having to be immersed in water, while still preserving the qualities of the label.

This paper for labels, which is certainly interesting because, with the liquid polymer, a layer that limits the propagation of the humidity between the paper and the substrate is obtained, does however have a certain number of disadvantages.

Thus, the layer of liquid polymer applied on this paper requires an additional passage off-machine which consequently increases the cost price of said paper. On the other hand, in order to maintain in contact the final label which comprises the layer of polymer on the bottle, the gluing must be carried out via an adhesive, with the effectiveness of conventional gluing, such as cold gluing, being compromised by the high hydrophobicity of the layer of polymer.

Moreover, said layer of liquid polymer does not make it possible to obtain a front-back printing of the label, as this type of printing is highly sought by producers of white wine in particular.

Finally, the presence of this layer of polymer on the rear face of the uncoated paper imposes an additional operation of orientation of the latter before the gluing and/or printing operation.

Also known is a multilayer paper such as the one described, for example, in international patent application WO 2007/048878. However, this paper has the disadvantage of being complex and therefore expensive to produce.

### DISCLOSURE OF THE INVENTION

The present invention therefore aims to overcome a certain number of the disadvantages of known papers for labels and to propose an opaque paper for labels which can withstand immersion which meets the four criteria described hereinabove while still being able to be printed front and back and by being particularly easy and less expensive to produce on a single production line, as such avoiding any subcontracting. Moreover, the label produced from this paper must be able to be maintained on the bottle regardless of the type of gluing used: conventional cold gluing or self-adhesive.

In this respect, the present invention has for object an uncoated opaque paper which can withstand immersion for the production of a label which is intended mainly for bottles of wines or spirits, remarkable in that it is constituted by a basic paper substrate which is constituted by fibres and opacifying mineral fillers, said basic paper substrate being subjected on the front and rear faces to a single surface treatment which is constituted by mineral pigments or other pigments, which are associated with hydrosoluble and synthetic binders.

It is well understood that with this configuration the opaque paper which can withstand immersion according to the invention can be printed and/or glued on one of its faces or on its two faces (front and rear)

The basic paper substrate is advantageously comprised of about 80% cellulose fibres.

Preferably, the opacifying mineral fillers of the basic paper substrate are chosen from the group comprising titanium dioxide, kaolin, talc, carbonate or titanium substituents.

According to a preferred embodiment, the surface treatment consists of a deposit of mineral pigments or other pigments which are associated with hydrosoluble and synthetic binders.

Advantageously, the mineral pigments or other pigments are chosen from the group comprising titanium dioxide, kaolin, talc, ATH, carbonate or titanium substituents and in that the hydrosoluble and synthetic binders are chosen from the group comprising native and chemically modified starches, PVAs, latexes or biolatexes.

The invention also relates to a method for the production of a label from opaque paper for labels according to the invention, remarkable in that it includes at least the following steps:

a/production of a sheet of basic paper substrate from fibres and opacifying mineral fillers, according in particular to the grammage, opacity and tint desired,

b/surface treatment on the front and rear faces of the basic paper substrate by depositing of mineral pigments or other pigments, which are associated with hydrosoluble and synthetic binders,

c/printing on the rear face or on the front and rear faces of the opaque paper for labels of desired information,

d/application of a gluing layer on one of the faces of the opaque paper for labels,

e/cutting of the sheet of printed paper to the dimensions of the label to be produced.

The invention finally relates to a label that is remarkable in that it is obtained from the method of producing described hereinabove.

### BRIEF DESCRIPTION OF THE FIGURES

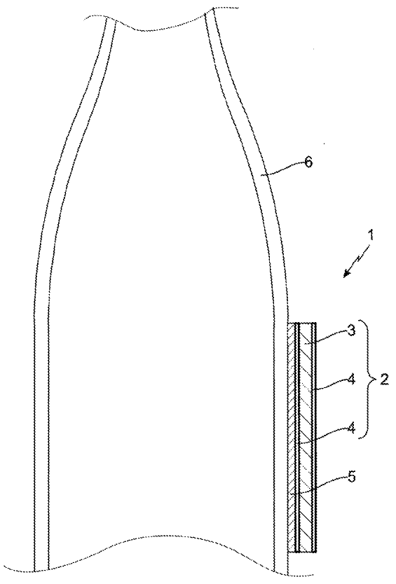

Other advantages and characteristics shall appear better in following description, of a particular embodiment, provided for the purposes of non-limited illustration, of an opaque paper for the production of labels in accordance with the invention, in reference to the sole FIG. 1 which diagrammatically shows, as a cross-section and on an enlarged scale, a label according to the invention, affixed on a bottle.

### BEST MODE FOR CARRYING OUT THE TECHNICAL INVENTION

In reference to FIG. 1 and in accordance with the invention, a label 1 is shown obtained from an opaque paper which can withstand immersion and intended to receive information at least on its rear face, to then be affixed on any substrate whatsoever, in particular a bottle 6 conventionally made of glass.

According to the invention, said opaque paper 2 for labels which can withstand immersion is formed from a basic paper substrate 3 comprised of cellulose fibres and/or of synthetic fibres, and of opacifying mineral fillers, said basic paper substrate 3 being subjected on the front and rear faces to a single surface treatment 4 which is constituted by mineral pigments or other pigments, which are associated with hydrosoluble and synthetic binders.

It is well understood that the fact that said basic paper substrate 3 receives only a single surface treatment 4 on its front and rear faces allows for a reduction in the cost of production thanks to the simplicity of the production line used to produce said paper 2 in accordance with the invention. Indeed, this paper 2 requires only one production line devoid of specific coating equipment and/or that has only one device for applying surface treatments.

The opaque paper 2 for labels is uncoated, i.e. it has not received any surface layer that tends to modify its aspect, and in particular to render its faces less rough.

Conversely, a coated paper according to the NFQ 26-001 standard is a paper of grammage greater than 72 g/m² of which the mass of the layer per face is greater than 10 g/m², with this coated paper then having smoother matt or glossy faces and which absorb less printing ink, which has the consequence of having in particular more vibrant colours.

The proportion of fibres in the basic paper substrate 3 is conventionally about 80%.

The opacifying mineral fillers intended to provide said basic paper substrate 3 with a dry and humid opacity are such as, for example, titanium dioxide, kaolin, talc, carbonate or titanium substituents.

However, advantageously, the use of titanium oxide will be avoided because, although it makes it possible to provide said paper for labels with a whiteness and an opacity that are particularly intense, it is expensive and can have risks.

In accordance with the invention, the basic paper substrate 3 is subjected on its front and rear faces to a surface treatment 4. The latter consists conventionally of a depositing, via any known technique, of mineral pigments or other pigments, which are associated with hydrosoluble and synthetic binders.

The mineral pigments or other pigments are advantageously chosen from the group comprising titanium dioxide, kaolin, talc, ATH (Aluminium Trihydrate), carbonate or titanium substituents. Likewise, the hydrosoluble and synthetic binders are chosen from the group comprising native and chemically modified starches, PVAs (polyvinyl alcohol), latexes or biolatexes.

The surface treatment 4 of each one of the front and rear faces of the basic paper substrate 3 improves the resistance characteristics in a humid environment by protecting the fibres of said basic paper substrate 3 from water.

Advantageously, it has been observed that the opaque paper 2 has a Cobb test value greater than or equal to 12, which renders it printable while still retaining its qualities of withstanding immersion.

After its surface treatment 4, in order to obtain a label 1 in accordance with the invention, the opaque paper 2 for labels is then printed on its rear face or on its front and rear faces by any known technique.

Finally, the opaque paper 2 for labels later receives a gluing layer 5 deposited by any means on its face intended to be put into contact with the bottle 6. This gluing layer 5 is indifferently obtained by a conventional cold gluing layer or by an adhesive in such a way as to obtain a self-adhesive label, said gluing layer 5 able to be implemented after the surface treatment 4.

The production of a label 1 from an opaque paper which can withstand immersion such as has just been described then includes at least the following steps:

a/production of a sheet of basic paper substrate 3 from fibres and opacifying mineral fillers, according in particular to the grammage, opacity and tint desired,

b/surface treatment 4 on the front and rear faces of the basic paper substrate 3 by depositing of mineral pigments or other pigments which are associated with hydrosoluble and synthetic binders,

c/printing on the rear face or on the front and rear faces of the opaque paper 2 for labels of desired information,

d/application of a gluing layer 5 on one of the faces of the opaque paper 2 for labels,

e/cutting of the sheet of printed paper to the dimensions of the label 1 to be produced.

Steps a and b are carried out in this order, while steps c, d and e can be carried out in a different order.

Thus, the gluing layer 5 can in certain cases be carried out before printing, without leaving the scope of the present invention.

Producing the opaque paper 2 which can withstand immersion in accordance with the invention thus makes it possible to produce a label 1 that satisfactorily remains resistant and opaque when it is placed in a humid environment for 24 h and even 48 hours.

Said opaque paper 2 makes it possible to have a gluing or a cold gluing indifferently on one or the other of its front and/or rear faces, that remain printable with inks and via conventional processes such as, for example, those that are used for uncoated paper.

Finally, the label 1 thus obtained has on its front and rear faces an uncoated paper finish that is aesthetically pleasing, both visually and to the touch.

The production line is simplified, which allows a substantial amount of time to be saved in the production of the label 1.

In addition, this method of production in a single production line makes it possible to limit the quantity of scrap, avoid transport and subcontracting costs, and to reduce production time.

Finally, it is well understood that using a basic paper which is constituted by fibres and opacifying mineral fillers and being subjected on the front and rear faces to only one surface treatment which is constituted by mineral pigments or other pigments, which are associated with hydrosoluble and synthetic binders, makes it possible to obtain an opaque paper that can withstand immersion and to produce said paper in a single pass on a single production line in order to limit the quantity of scrap, avoid the transport and subcontracting costs, and reduce production time.

### INDUSTRIAL APPLICABILITY

It is understood that the label 1 which can withstand immersion in accordance with the invention is particularly intended for an application on bottles of wines or spirits. However, it is obvious that this label 1 can be adapted and used on other types of containers.

Finally, it goes without saying that the examples of paper and of label 1 in accordance with the invention which have just been described are only particular illustrations, and in no case limit the invention.

1-7. (canceled)

8. An uncoated opaque paper which can withstand immersion for the production of a label which is intended mainly for bottles of wines or spirits, wherein it is constituted by a basic paper substrate which is constituted by about 80% cellulose fibres and opacifying mineral fillers, chosen from the group comprising titanium dioxide, kaolin, talc, carbonate or titanium substituents, said basic paper substrate being subjected on the front and rear faces to a single surface treatment which is constituted by mineral pigments or other pigments, chosen from the group comprising titanium dioxide, kaolin, talc, ATH, carbonate or titanium substituents, which are associated with hydrosoluble and synthetic binders, chosen from the group comprising native and chemically modified starches, PVAs, latexes or biolatexes.

9. A paper according to claim 8, wherein the surface treatment includes a deposit of mineral pigments or other pigments which are associated with hydrosoluble and synthetic binders.

10. A method for producing a label from opaque paper for labels according to claim 8, further comprising it includes at least the following steps:
a/production of a sheet of basic paper substrate from fibres and opacifying mineral fillers, according in particular to the grammage, opacity and tint desired,
b/surface treatment on the front and rear faces of the basic paper substrate by depositing of mineral pigments or other pigments which are associated with hydrosoluble and synthetic binders,
c/printing on the rear face or on the front and rear faces of the opaque paper for labels of desired information,
d/application of a gluing layer on one of the faces of the opaque paper for labels,
e/cutting of the sheet of printed paper to the dimensions of the label to be produced.

11. A label wherein it is obtained from the method for producing according to claim 10.
